(19) United States
(12) Patent Application Publication
(10) Pub. No.: US 2023/0003702 A1
(43) Pub. Date: Jan. 5, 2023

(54) OPTICAL PH SENSOR

(71) Applicant: ABBERIOR GMBH, Götlingen (DE)

(72) Inventor: Shamil NIZAMOV, Göttingen (DE)

(73) Assignees: ABBERIOR GMBH, Göttingen (DE); ABBERIOR GMBH, Göttingen (DE)

(21) Appl. No.: 17/642,759

(22) PCT Filed: Sep. 15, 2020
(86) PCT No.: PCT/EP2020/075714

§ 371 Date: Mar. 14, 2022

(30) Foreign Application Priority Data
Sep. 16, 2019 (DE) 10 2019 124 795.0

(51) Int. Cl. G01N 31/22; G01N 21/80

(52) U.S. Cl. CPC G01N 31/221; G01N 21/80; G01N 2021/7786

(57) ABSTRACT

The present disclosure relates to a pH sensor for determining the pH of an aqueous medium at least comprising a polymeric matrix comprising embedded phosphorescent nanoparticles and one or more embedded fluorescent dyes, wherein the phosphorescent nanoparticles comprise transition metal complexes having central atoms selected from the group consisting of Ru, Re, Os, Rh, Ir, Pt and the fluorescent dye comprises fluorescein derivatives according to the following formula I

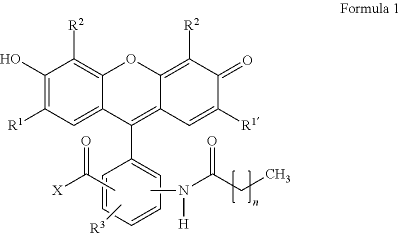

or charged structures thereof, wherein n is greater than or equal to 5 and less than or equal to 20, X═—O—, —OH, —OR⁴, —NH₂, —NH— or NHR⁴, wherein R⁴ is selected from the group consisting of C1-C20 alkyl and the R¹, R^{1′}, R², R³ are independently selected from the group consisting of H, D, substituted or unsubstituted C1-C20 alkyl and halogen. Furthermore, the present disclosure comprises a method and a system for determining pH.

### CROSS-REFERENCE TO RELATED APPLICATIONS

This application is a U.S. National Phase Application under 35 U.S.C. 371 of International Application No. PCT/EP2020/075714, filed on Sep. 15, 2020, which claims the benefit of German Patent Application No. 10 2019 124 795.0, filed on Sep. 16, 2019. The entire disclosures of the above applications are incorporated herein by reference.

### FIELD

The present disclosure relates to a pH sensor for determining the pH of an aqueous medium at least comprising a polymeric matrix comprising embedded phosphorescent nanoparticles and one or more embedded fluorescent dyes, wherein the phosphorescent nanoparticles comprise transition metal complexes having central atoms selected from the group consisting of Ru, Re, Os, Rh, Ir, Pt and the fluorescent dye comprises fluorescein derivatives according to the following formula I

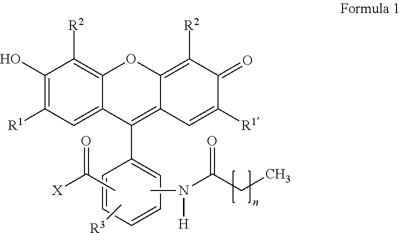

or charged structures thereof, wherein n is greater than or equal to 5 and less than or equal to 20, X═—O—, —OH, —OR⁴, —NH₂, —NH— or NHR⁴, wherein R⁴ is selected from the group consisting of C1-C20 alkyl and the R¹, R^{1′}, R², R³ independently selected from the group consisting of H, D, substituted or unsubstituted C1-C20 alkyl and halogen. Furthermore, the present disclosure comprises a method and a system for determining pH.

### BACKGROUND

This section provides background information related to the present disclosure which is not necessarily prior art.

The reliable determination of the pH value is essential for the comprehensive investigation and process control of reaction processes in biological and chemical systems. Since the beginnings of modern chemistry, optical acid-base indicators such as litmus, phenolphthalein or methyl red have been known whose light absorption properties, i.e. their color, change depending on the hydroxonium ion concentration present. However, for flexible use in the industrial environment and especially for continuous measurements, electrochemical methods have finally become established which record the pH value of aqueous solutions via a change in the electrochemical potential of a metal electrode. The electrochemical determination is sufficiently robust with respect to the chemical environment of the measured solution and can be used in a wide range of pH values, provided that suitable calibration is used. Only in recent years have optical systems that use the luminescence properties of organic molecules instead of the absorption properties come back into focus, especially for biotechnological applications. The luminescence of a molecule can also change depending on the current charge state, and by a suitable choice of luminophore, systems can be provided which show large changes in optical properties in specified pH ranges. In these applications, fluorophores are used whose fluorescence and/or phosphorescence is a function of pH. Compared to the electrochemical systems, tailor-made, more “sensitive” optical systems are available, which can achieve a higher precision in a selective measuring range.

Combination systems of two different luminophores are particularly suitable for use in bioreactors, with one of the luminophores exhibiting pH-independent phosphorescence and the other luminophore exhibiting pH-dependent fluorescence. The centers are excited simultaneously by irradiation of light of suitable wavelength and, in response, a sum signal with different intensity contributions is obtained in the time domain. Shortly after excitation, both fluorescence and phosphorescence components are obtained in an early detection period, whereas phosphorescence components predominate at a later time. From the intensity ratio of the pH-dependent early components (phosphorescence+fluorescence) and the pH-independent later components (phosphorescence), the pH value can be obtained, assuming a suitable calibration, independent of the turbidity of the measuring solution and more stable against fluctuations of the optical system.

A general method for determining the pH value via the determination of a ratio of phosphorescent and fluorescent contributions is known from the prior art. For example, EP 1 000 345 B1 describes a method for luminescence determination of a biological, chemical or physical parameter of a sample using at least two different luminescent substances (flu, ref), the first (flu) of which responds to the parameter at least in luminescence intensity and the second (ref) of which does not respond to the parameter at least in luminescence intensity and decay time, the luminescent substances (flu, ref) having different decay times, characterized in that the decay time of the second luminescent substance (ref) is longer than that of the first luminescent substance (flu) and that the time or phase behavior of the additively superimposed luminescence responses of both luminescent substances is measured by a single detector and that a reference quantity independent of the total intensity of both luminescent substances is obtained from the measured time or phase behavior and that the parameter is determined using the reference quantity.

Mixed electrical/optical sensors are also known from the prior art. For example, DE 10 2012 021 933 A1 discloses an optical sensor, in particular for pH values, with a photoluminescent and or fluorescent layer, light source and detector, wherein the at least one photoluminescent and or fluorescent layer has at least one electrical contact and thus acts as a working electrode and the pH sensor is equipped with at least one counter electrode and at least one reference electrode and the photoluminescent layer has a potential.

The incorporation of luminophores into organic matrices for the determination of physical parameters is also known. For example, U.S. Pat. No. 6,051,437 A1 discloses an opto-chemical probe comprising at least one dye for detecting the presence of chemical analytes and a polymeric film for binding the at least one dye, the polymeric film consisting of successive layers of anionic and cationic polyelectrolytes.

A disadvantage of the double luminophore systems is that for reliable determination of the pH value, the two luminophores must be located at a suitable distance from each other and in a liquid-permeable matrix. The latter in order to achieve a fast and intimate contact with the medium to be measured. For this reason, the optical probes are usually embedded in porous polymer matrices, which mechanically stabilize the system and provide suitable diffusion properties. High liquid permeability of the matrix is particularly important for fast response, but usually leads to luminophore losses, which are caused by washout of the fluorescent or phosphorescent centers from the matrix. A suitable combination of high sensitivity, fast response, large dynamic measurement space and long sensor lifetime is therefore difficult to achieve.

Despite the optical pH measurement systems already known in the field of analytics, there is still an interest in new pH sensors which are able to deliver highly accurate and reproducible results even under difficult boundary conditions of the analysis method and which have a long service life.

### SUMMARY

This section provides a general summary of the disclosure, and is not a comprehensive disclosure of its full scope or all of its features.

This task is fulfilled by the pH sensor described in the independent claims, the method for determining the pH according to the disclosure and the system according to the disclosure. Preferred embodiments thereof are set forth in the dependent claims.

According to the disclosure, the pH sensor for determining the pH of an aqueous medium comprises at least one polymeric matrix comprising embedded phosphorescent nanoparticles and one or more embedded fluorescent dyes, wherein the phosphorescent nanoparticles have transition metal complexes with central atoms selected from the group consisting of Ru, Re, Os, Rh, Ir, Pt; and the fluorescent dye is a fluorescein derivative according to the following formula I

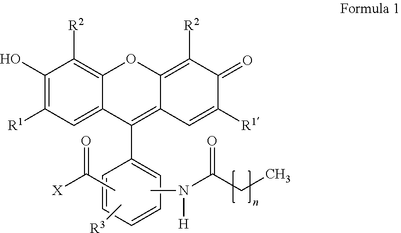

or charged structures thereof, wherein n is greater than or equal to 5 and less than or equal to 20, X═—O—, —OH, —OR⁴, —NH₂, —NH— or NHR⁴, wherein R⁴ is selected from the group consisting of C1-C20 alkyl and the R¹, R^{1′}, R², R³ are independently selected from the group consisting of H, D, substituted or unsubstituted C1-C20 alkyl and halogen. Surprisingly, it was found that the above structure of polymeric matrix with the two claimed different classes of luminophores, one of the classes having pronounced phosphorescent and the other class having pronounced fluorescent properties, leads to a particularly efficient and sensitive pH sensor, the measured values of which are, moreover, largely stable with respect to a wide range of further side influences, such as ionic strength. In particular, it should be emphasized that, compared to the solutions described in the prior art, a significantly improved sensitivity results. Thus, an extremely sensitive sensor is provided in the measuring range, which shows a fast response to a changed pH value of the measuring medium. The luminophores are anchored in the polymer matrix in a washout-proof manner, so that there is only an extremely slight change in the intensity of the signals even after long periods of time. Without being bound by theory, these positive properties result in particular from the special attachment of the fluorescent component in the polymer matrix. This seems to succeed particularly efficiently via the direct attachment of a longer alkyl chain in the —NHCO-alkyl group, so that losses of this component into the measurement medium can be reduced. This is surprising, since the group to be used according to the disclosure is located rather close to the fluorescent core of the molecule and steric shielding to the further polymer matrix should result from the remaining, rather voluminous, substituents. However, this is apparently not the case, so that this functional group binds more stably to different polymer backbones, possibly via electrostatic interactions, so that over time unwanted detachment of this component is efficiently suppressed. Overall, this results in an efficient pH sensor with long-term stability. Furthermore, it is possible to adjust the measuring range of the pH sensor via the type of R¹ residues, so that different pH measuring ranges can be measured with a high sensitivity with only minor modifications to the fluorophore. The result is a flexible system that can be easily adapted to the existing measurement task.

The pH sensor according to the disclosure is suitable for determining the pH value of an aqueous medium. The pH value is defined in the usual way in chemistry as the negative decadic logarithm of the hydrogen ion concentration or, better, its activity. For the purposes of the disclosure, an aqueous medium is one in which the water content of the solution in which the pH sensor is present has a volume fraction greater than or equal to 50%, preferably greater than or equal to 70%, and further preferably greater than or equal to 80%. The aqueous medium may of course contain other components such as salts, organic solvents, biological components, dissolved gases or other solid components.

The pH sensor comprises a polymeric matrix having embedded phosphorescent nanoparticles and one or more embedded fluorescent dyes. In this regard, a polymeric matrix comprises at least one polymer network, preferably having hydrophilic and hydrophobic domains, wherein the individual polymer chains of the network may be connected to each other via physical or covalent interactions. The network forms a physical protection and ensures that the luminophores largely keep their place in the measuring solution and do not contaminate the measuring solution. The network also allows good water transport, which is not disturbed by the presence of high concentrations of optical probes. Preferably, the network is porous and thus permits the entry of the measurement medium, if necessary with water absorption, i.e. swelling, of the entire network.

The polymer network has nanoparticles comprising substances or complexes which exhibit phosphorescent properties after irradiation with a light source. That is, the substances can be converted into an electronically excited state by absorption of a light quantum, and this electronically excited state is in turn converted into the electronic ground state on a long time scale by emission of a light quantum. Preferably, the phosphorescence lifetime of the phosphorescent luminophore is greater than or equal to 200 ns. In addition to the phosphorescent compound, the matrix also has fluorescent compounds that can also transition to an electronically excited state by receiving a light quantum. These excited states also decay under emission of a light quantum, but, compared to the phosphorescent luminophores, on a much shorter time scale (for example, in the ns range). Common fluorescence lifetimes can be, for example, below 15 ns, preferably below 10 ns, and further preferably below 7 ns. The two classes of luminophores are, for example, homogeneously distributed in the polymeric matrix.

The phosphorescent nanoparticles have transition metal complexes with central atoms selected from the group consisting of Ru, Re, Os, Rh, Ir, Pt. The phosphorescent luminophores are thus formed by metal complexes embedded in nanoparticles. Embedding the metal complexes in nanoparticles can be achieved, for example, by depositing metal complexes capable of phosphorescence together with one or more polymers in nanoparticulate form. For example, the phosphorescent complexes can be built up with above-mentioned central atoms with the access of organic as well as inorganic ligands, which are then subsequently embedded in a polymer. This polymer/metal complex mixture can then be deposited or obtained in the form of nanoparticles by methods known to those skilled in the art. By incorporating the phosphorescent metal complexes into the nanoparticles, the nanoparticles can be protected from the entry of other undesirable substances, such as oxygen, and the phosphorescent metal complexes can be further immobilized in the polymeric matrix of the sensor. In a preferred embodiment, the central atoms of the transition metal complexes may be selected from the group consisting of Ru, Ir and Pt.

The fluorescent dye to be used according to the disclosure is a fluorescein derivative of the following formula I

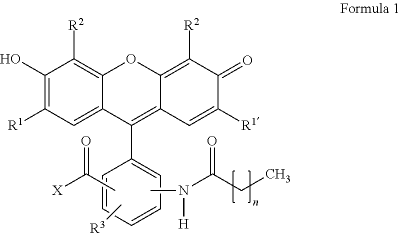

where the chemical composition of the dye also includes its charged structures. This means that, depending on the resonance structure, one or more hydrogens may be attached to or abstracted from the binding centers. Furthermore, it is also possible that a ring structure is formed on the basic structure of the fluorophore via the CO—X Markush group. This is expressed by the fact that, for example, X for hydroxyl is also possible in the form —O—. Thus, it is possible that this Markush formula represents a carboxylic acid group (CO—X with X═—OH) or also a compound in which the carboxylic acid group is cyclically present by linkage to the other structures of the fluorophore. These are tautomeric structures which are formed by reaction of the carboxylic acid group with further structures of the ring skeleton with elimination of the hydrogen proton. The bonds on either side of the oxygen thus indicate incorporation into a cyclic structure, which is formed by rearrangement. Typically, this is an equilibrium reaction, with the proportions of cyclic and non-cyclic structures determined by the remaining structure of the fluorophore and the chemical environment. Open and closed structures can result for the fluorophores of the disclosure, although for clarity the other functional groups of the fluorophore are not shown in the schematic below:

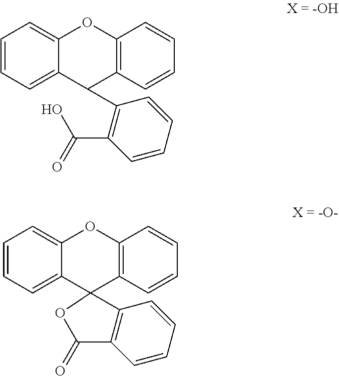 [SMILES: O=C(O)c1ccccc1C1c2ccccc2Oc2ccccc21 ; O=C1OC2(c3ccccc3Oc3ccccc32)c2ccccc21]

Both forms are usually present in equilibrium with each other, whereby the position of the equilibrium and thus also the predominant structural form is determined by the chemical environment. In the case where X represents a nitrogen-containing group, of course, the same applies. In the case where X represents an —OR group, of course, no closed structures can be formed.

To define the individual Markush groups for formula I given above, n is greater than or equal to 5 and less than or equal to 20, X═—O—, —OH or —NH₂ or —NH— and the R¹, R^{1′}, R², R³ may be independently selected from the group consisting of H, D, substituted or unsubstituted alkyl and halogen. Thus, the index n may encompass the above range of values, with larger values for n being capable of degrading water transport in the polymeric matrix. The R¹ to R³ in formula I may independently comprise a substituted or unsubstituted alkyl radical, where Akyl is a hydrocarbon radical having up to 8 C-atoms. This hydrocarbon radical may have one, two or three substituents, such as —OH, halogens, —CN, NO₂. The halogens can be selected in particular from the group Cl, F, Br. The fluorescence properties of the fluorophore can be influenced by these groups. For R¹ and R^{1′} in particular, it has been found that the position of the pH measurement range can be altered via the chemical properties of these radicals. If electron-withdrawing groups, such as fluorine, are used for R¹, the measuring range of the sensor can be shifted into the acidic range. For example, measurement windows up to pH 5 can be realized. If electron density donating groups, such as alkyl groups, are used at these positions, the measuring range can be shifted into the alkaline range up to pH 8. The sensor can thus be flexibly tuned and adapted to the environment to be measured by the appropriate choice of these substituents. Furthermore, in a preferred embodiment, n can be greater than or equal to 8 and less than or equal to 20 and furthermore greater than or equal to 9 and less than or equal to 18.

In a preferred embodiment of the pH sensor, n may be greater than or equal to 10 and less than or equal to 18. In particular, the longer alkyl chains can contribute to improved stability and sensitivity of the sensor. Especially with n=10 to 16, long sensor lifetimes result, with only a slight drop in intensities due to washout observable when the sensor is run in. This indicates that the sensor with this number of C atoms in this side chain is very well anchored in the polymer matrix.

In a further preferred embodiment of the pH sensor, X═—OH or —O—. For a particularly quantum-efficient and “washout-proof” compound, it has been found to be favorable that the Markush group with the X has a carboxylic acid group or its further reaction product in the form of a cyclic compound. This configuration of the X group can increase the longevity of the sensor.

In another preferred characteristic of the pH sensor, the fluorescent dye may be a 5-N-(octadecanoyl)aminofluorescein according to the following structural formula II

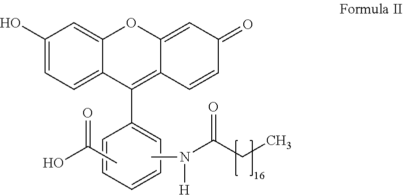

This fluorophore in particular can be efficiently bound to the polymeric matrix via the substitution pattern presented, so that pH sensors are available which, in addition to high quantum efficiency, exhibit a fast response, very high accuracy and very high long-term stability, i.e. only a low degree of washout.

Within a preferred embodiment of the pH sensor, the fluorescent dye may be a 5-N-(octadecanoyl)aminofluorescein according to the following structural formulae IIIA or IIIB

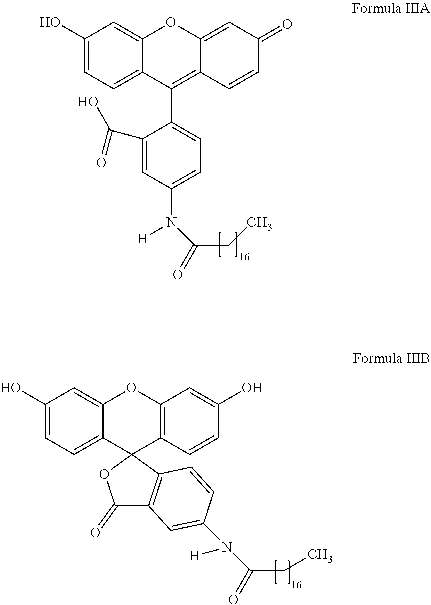

These two tautomeric forms have been shown to be particularly sensitive and washout resistant. In addition, these fluorophores show a particularly large change in fluorescence behavior as a function of pH.

In another aspect of the pH sensor, the polymeric matrix may be selected from the group consisting of HYPAN, polyurethane, poly-hema, or mixtures of at least two components thereof. Binding of the luminophores that can be used in accordance with the disclosure to polymers mentioned above has been shown to be particularly efficient and stable over time. Without being bound by theory, this also results highly likely from the substitution pattern of the fluorophore according to the disclosure with the attachment of a longer alkyl chain to the —NHCO— group. This combination may help to reduce losses of this component into the measurement medium.

To further improve long-term stability, additives, such as ceramic nanoparticles, can be incorporated into the polymeric matrix. For example, it has been shown that long-term stability can be further improved by the addition of titanium dioxide nanoparticles, although sensitivity may be somewhat reduced and response somewhat delayed. However, these disadvantages may be of less importance for long-term measurements, so the addition of aggregates may be an advantageous alternative.

In a further embodiment of the pH sensor, the polymer matrix can comprise a proportion by weight of greater than or equal to 75% and less than or equal to 100% polyurethane. The luminophores that can be used according to the disclosure can be coupled particularly well to polyurethanes and thus lead to sensors that are particularly stable over long periods. Without being bound by theory, this appears to be attributable to the interaction of especially the —HNCO group and the alkyl group of the fluorophore coupled thereto with the backbone of the polyurethane. On the one hand, this may be due to the particular electrostatic interactions between the different oxygen and nitrogen atoms of the functional group of the fluorophore and to the van der Wals interactions of the alkyl chain present on this group with the polymer backbone mentioned above. Further preferably, the polyurethane content may be greater than or equal to 85%, preferably greater than or equal to 90% (wt %). The proportion is obtained as the proportion of the polymers forming the matrix and can be determined after dissolution of the matrix by conventional HPLC methods.

In a preferred embodiment of the pH sensor, the phosphorescent nanoparticles may have a Ru central atom. Nanoparticles with metal complexes comprising ruthenium central atoms have proven to be particularly suitable for the combination of the two different luminophores that can be used according to the disclosure. High quantum yields result and, moreover, the spectral excitation properties between the phosphorescent and fluorescent centers are sufficiently equal that excitation of both can be achieved via light of a narrow spectral range. This can help to simplify the design and optics of the sensor.

In another embodiment of the pH sensor, the phosphorescent nanoparticles can be formed by embedding Ru(dpp)₃Cl₂ in a matrix of polyacrylonitrile. Especially the combination of tris(4,7-diphenyl-1,10-phenanthroline)ruthenium(II) dichloride complex embedded in an acrylonitrile with the fluorescent luminophores of the disclosure can contribute to a high quantum yield and a stable system. Thus, the nanoparticles have ruthenium central atoms with diphenyl-phenanthroline ligands, which exhibit long luminescence lifetime, high quantum yields, and excellent thermal and chemical stability. In this respect, nanoparticles equipped in this way are particularly suitable for use with the fluorescent luminophores that can be employed according to the disclosure.

Further according to the disclosure is a method for determining the pH of an aqueous medium, wherein the aqueous medium is contacted with the pH sensor according to the disclosure and the fluorescence properties of the composition are determined by irradiating the composition with light and recording the fluorescence response of the composition. By using the method according to the disclosure, the pH value in aqueous media can be determined with high precision and over a long observation period. This method is particularly suitable for use in bioreactors, since the actual determination of the optical properties of the sensor can be performed from “outside”. In this respect, a simple separation of the different measurement components within the method can be achieved. Furthermore, explicit reference is made to the advantages of the pH sensor according to the disclosure for the advantages of the method according to the disclosure.

Furthermore, according to the disclosure, there is a system for determining the pH of an aqueous medium, the system comprising a light source set up to emit light of a specific wavelength range; a pH sensor according to the disclosure; an optical sensor set up to detect time- and wavelength-resolved light signals; and an evaluation unit set up to determine the intensity of the time- and wavelength-resolved light signals. By means of the above system, very long-life time stable pH value measurements can be performed. In particular, systems according to the disclosure can track the pH of aqueous solutions in a pH range from about 4 to 9 over a period of up to several days with a high degree of precision. In this context, a single system according to the disclosure can be adapted to a narrower range of pH values, e.g., to a range of values from 5 to 8, in which it exhibits a particularly high sensitivity. Blue LEDs can preferably be used as light sources for measuring the optical properties. For further advantages of the system according to the disclosure, reference is made to the advantages of the pH sensor according to the disclosure.

### EXAMPLES

The production of the pH sensor according to the disclosure can be carried out in three steps, for example:

Step 1: Preparation of Luminescent Nanoparticles from Polyacrylonitrile and Ru(Dpp)₃Cl.₂

A polyacrylonitrile nanoparticle with an average particle diameter below 100 nm is prepared by dispersion polymerization. A mixture of acrylonitrile (6 ml), Ru(dpp)₃Cl₂ (tris(4,7-diphenyl-1,10-phenanthroline)ruthenium(II) dichloride, 10 mg) in DMF (2 mL), PVA (MW=80 kDa, 1 mg), AIBN (1 mg) and water (150 ml) is heated to about 60° C. and stirred for 20 hours. The resulting precipitate is separated by centrifugation and washed with 50% aqueous ethanol and water. The phosphorescent nanoparticles are then suspended in water (50 mL).

Step 2: Preparation of the Dye Solution with Fluorescent Dye Molecules

A solution 2 is prepared by dissolving 5-(N-octadecanoyl)-aminofluorescein in 90% aqueous ethanol. A concentration of 5 mM is obtained.

### Step 3: Preparation of the Polymer Matrix

A solution 3 is prepared by dissolving hydrogel D4 in 90% (v/v) aqueous ethanol. A concentration of 4% (w/w) is obtained.

### Step 4: Preparation of the pH Sensor

Suspension 1, solution 2 and solution 3 are mixed in a ratio of 1:4:20 (v/v/v) until a homogeneous distribution of the solutions/suspension is achieved. The homogeneous mixture is applied to a flat plate in a layer thickness of approx. 1 μm and dried under heating.

### Washout of the Optical Sensor in a Blind Test

A solution of hydrogel D4 in 90% (v/v) aqueous ethanol is mixed together with an aqueous suspension of Ru nanoparticles (2% w/w). 4 samples were taken from the resulting mixture and 1 g of each was mixed with different fluorescein derivatives. The resulting samples are as follows:
Sample 1 (blank): without fluorescein derivative
Sample 2 (C0): 5-aminofluorescein (5 μmol).
Sample 3 (C12): 5-Dodecanoylaminofluorescein (5 μmol)
Sample 4 (C18): 5-octadecanoylaminofluorescein (5 μmol).

Each sample was placed in a 250 ml flask and dried for 24 hours. To each of the dried matrices, 100 ml of an ammonia buffer solution pH=9.5 is added and each flask was stirred at 37° C. for 72 h. The aqueous solution is then filtered and lyophilized. After cooling to room temperature, the aqueous solution is filtered off and lyophilized. The amount of material washed out is calculated according to the following formula: % (washout)=[m(residue)−m(blank)]/m(Cx).

| Sample | CO | C12 | C18 |
|---|---|---|---|
| Wash out | 7,2% | 5,7% | 1,2% |

The amount of material washed out results both from the optical components of the system and from the matrix material itself. The washout experiments show that only an extremely small amount of the sensor is dissolved from the matrix. In addition, longer C-chains on the nitrogen seem to reduce the amount of washed out material.

### Calibration of the pH Sensor

The sensor produced by process steps 1-3 was calibrated using PBS buffer solutions. The PBS buffer has an ionic strength I of 0.142 at a pH of approximately 7.4. 0.142M hydrochloric acid or 0.142 M NaOH solution was used to adjust the different pH values in the range between pH 5.0 and pH 9.0. The pH at each data point was measured after a calibration period of at least 4 minutes. Measurements were performed at room temperature (+−1° C.). A digital pH meter was used to determine the respective pH values at the calibration points.

The composition of the buffer at pH 7.4 is given via the table below.

| | | Input quantity | Input quantity |
|---|---|---|---|
| Reagent | MW in g | in g | in mol |
| Na₂HPO₄ | 141.95 | 1.419 | 0.010 |
| KH₂PO₄ | 136.08 | 0.244 | 0.001 |
| NaCl | 58.44 | 8.006 | 0.137 |
| KCl | 74.55 | 0.201 | 0.002 |

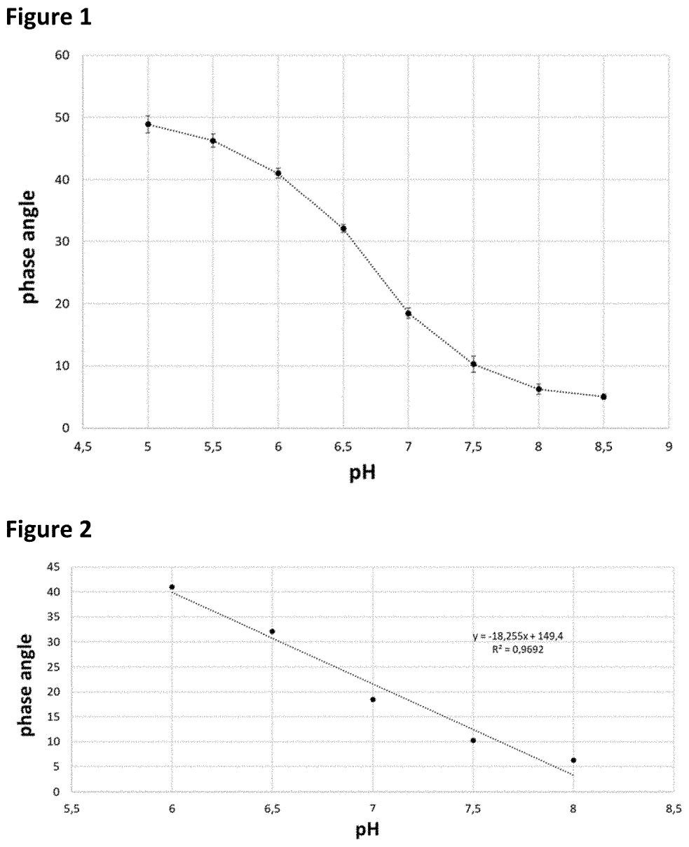

The results of the calibration curve are shown in FIG. 1. The curve shows the dependence of the phase angle on the pH value. The measurement points shown result from the mean value of four independent measurements. The error bars result from the standard deviation of the measurements per pH value. It can be seen that the nanoparticle, polymer and fluorophore system of the disclosure shows a very large difference in phase angle as a function of pH (FIG. 2). In other words, the system according to the disclosure is a very sensitive system, resolving even the smallest changes in pH via a large change in phase angle. This is particularly the case in the range between pH 6.0 and pH 8.0. In addition, the system shows an extremely low standard deviation for different batches, so that the system according to the disclosure is suitable for very reproducible measurements. Looking at the range around a pH of 6.5 with a delta pH of +−1.5, a slope of the phase angle as a function of pH of about 18.2 (° per pH unit with an R² of 0.96) is found via linear regression. This spread is larger compared to commercially available systems and thus the system according to the disclosure forms an extremely sensitive optical instrument for the determination of the pH value.

### Stability of the pH Sensor in Solution

The system from manufacturing steps 1-4 is used as the pH sensor. The pH sensor is placed on the exposed wall of a transparent termination piece for an optical fiber. The sensor prepared in this way is inserted into a bioreactor and by means of the sensor, the pH of the aqueous solution in the bioreactor is monitored over a period of days at room temperature. The solution was stirred during the measurement. A PBS solution with a pH of 7.0 was used as the measurement medium.

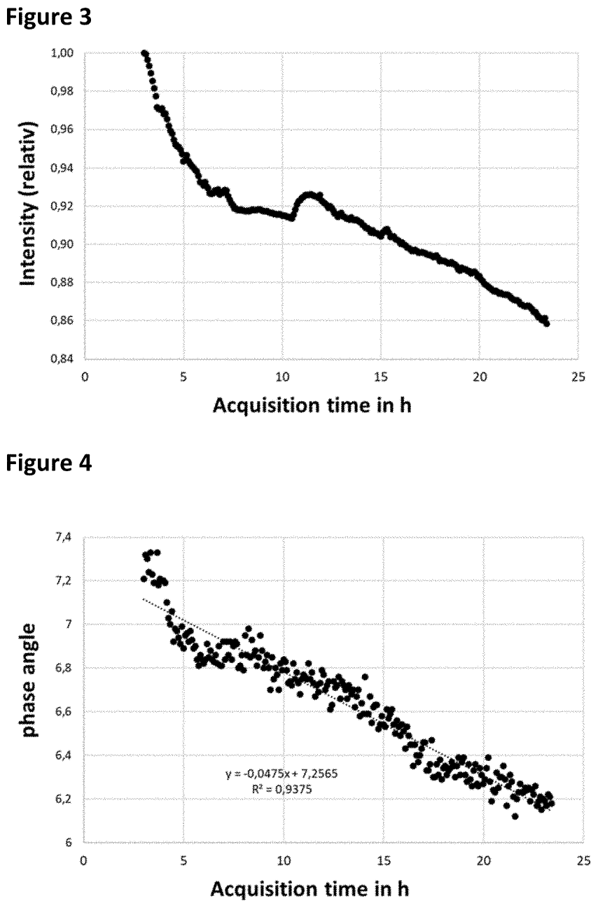

By using a buffer, the pH of the solution should actually be constant. It is found that both the measured intensity and the phase angle change over time. The intensity variation over approximately one day of measurement time is shown in FIG. 3 and the phase angle variation is shown in FIG. 4. Both the intensity and the phase angle decrease over the course of the measurement. The decrease of the measured values can be caused by the washing out of the sensor(s) (nanoparticle or fluorophore) or by bleaching, i.e. light-induced degradation, of one of the components. Further investigations show that the main part of the intensity and phase angle change can be attributed to bleaching of the nanoparticles. Surprisingly, the fluorophore according to the disclosure is much more stable against light-induced degradation compared to the nanoparticles used. In addition, further investigations have shown that the loss fraction caused by leaching is very small (see above). Overall, it can be stated that the phase angle in particular is extremely stable over the measurement time. Considering the results from the calibration, one obtains that as a function of pH, the phase angle changes by about 18° per pH unit. From the linear regression of the measurement carried out here, a change in the phase angle of approx. 0.047° per hour is obtained (regression from FIG. 4). In purely mathematical terms, this results in a change in the pH value of approx. 0.0026 per hour. This change can be described as extremely small.

These results could also be reproduced for another fluorophore, namely 5-N-(dodecanoyl)aminofluorescein (data not shown). The further fluorophore shows a very comparable spreading of the phase angle as a function of pH as well as a similar time-dependent course of the phase angle and intensity. This is surprising, since one would expect at least a different contribution due to a changed washout behavior due to the different chain lengths of the fluorophore. Thus, it becomes clear that the setup according to the disclosure with the fluorophores that can be used according to the disclosure is suitable to a high degree for the optical determination of the pH value in aqueous solutions due to the high spreading and the small amount of leaching and bleaching.

The foregoing description of the embodiments has been provided for purposes of illustration and description. It is not intended to be exhaustive or to limit the disclosure. Individual elements or features of a particular embodiment are generally not limited to that particular embodiment, but, where applicable, are inter-changeable and can be used in a select-ed embodiment, even if not specifically shown or described. The same may also be varied in many ways. Such variations are to be regarded as a departure from the disclosure, and all such modifications are intended to be included within the scope of the disclosure.

1. A pH sensor for determining the pH of an aqueous medium at least comprising a polymeric matrix having embedded phosphorescent nanoparticles and one or more embedded fluorescent dyes, characterized in that the phosphorescent nanoparticles comprise transition metal complexes with central atoms selected from the group consisting of Ru, Re, Os, Rh, Ir, Pt; and the fluorescent dye is a fluorescein derivative according to the following formula I 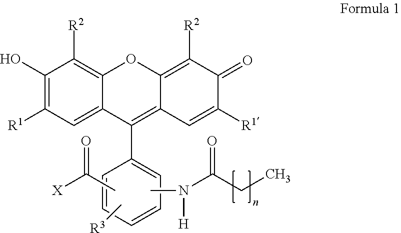
or charged structures thereof, wherein n is greater than or equal to 5 and less than or equal to 20, X═—O—, —OH, —OR⁴, —NH₂, —NH— or NHR⁴, wherein R⁴ is selected from the group consisting of C1-C20 alkyl and the R¹, R^{1′}, R², R³ are independently selected from the group consisting of H, D, substituted or unsubstituted C1-C20 alkyl and halogen.

2. The pH sensor of claim 1, wherein n is greater than or equal to 10 and less than or equal to 18.

3. The pH sensor according to claim 1, wherein X═—OH or —O—.

4. The pH sensor according to claim 1, wherein the fluorescent dye is a 5-N-(octadecanoyl)aminofluorescein according to the following structural formula II.

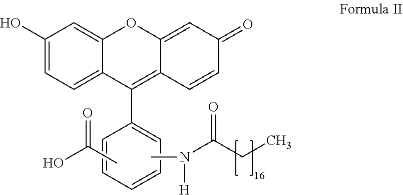

5. The pH sensor according to claim 1, wherein the polymeric matrix is selected from the group consisting of HYPAN, polyurethane, poly-hema, or mixtures of at least two components thereof.

6. The pH sensor according to claim 1, wherein the polymeric matrix comprises polyurethane at a weight percentage greater than or equal to 75% and less than or equal to 100%.

7. The pH sensor according to claim 1, wherein the phosphorescent nanoparticles comprise a Ru central atom.

8. The pH sensor according to claim 1, wherein the phosphorescent nanoparticles are formed by embedding Ru(dpp)₃Cl₂ in a matrix of polyacrylonitrile.

9. A method for determining the pH of an aqueous medium, wherein the aqueous medium is contacted with a pH sensor according to claim 1 and the fluorescence properties of the composition are determined by irradiating the composition with light and recording the fluorescence response of the composition.

10. A system for determining the pH of an aqueous medium comprising a light source arranged to emit light of a specific wavelength range; a pH sensor according to claim 1; an optical sensor arranged to detect time- and wavelength-resolved light signals; and an evaluation unit arranged to determine the intensity of the time- and wavelength-resolved light signals.
